(19) United States
(12) Patent Application Publication
(10) Pub. No.: US 2019/0139518 A1
(43) Pub. Date: May 9, 2019

(54) Resonator for Wind Instruments

(71) Applicant: Maurizio Cialfi, Grosseto (IT)

(72) Inventor: Maurizio Cialfi, Grosseto (IT)

(21) Appl. No.: 16/099,830

(22) PCT Filed: May 12, 2017
(86) PCT No.: PCT/IB2017/052805

§ 371 Date: Nov. 8, 2018

(30) Foreign Application Priority Data
May 12, 2016 (IT) UA2016A003372
Nov. 18, 2016 (IT) 202016000116853

(51) Int. Cl. G10D 7/06; G10D 7/10; G10D 9/06; G10D 7/08

(52) U.S. Cl. CPC G10D 7/066; G10D 7/10; G10D 7/063; G10D 7/08; G10D 9/06

(57) ABSTRACT

The resonator (1) is associated with wind instruments (S) of the type comprising a bell (C) located in correspondence of its main opening (A). The resonator (1) comprises a resonator element (2) preferably having a concave shape, supported within or in front of the bell (C) so that said concavity is directed towards the latter and that between the same resonator element (2) and bell (C) is defined a light passage (3). The resonator element (2) is aimed to define an auxiliary harmonic box intended for intercepting and reflecting or diverting the output sound waves from said bell (C) in order to increase its power, vary its timbre and/or improve the sound diffusion.

This is the national phase application of PCT/IB2017/052805 filed on 12 May 2017, the disclosure of which is hereby incorporated by reference.

### FIELD OF THE INVENTION

The present invention fits in the technical field of musical instruments, with particular reference to wind instruments.

### BACKGROUND OF THE INVENTION

As is well-known, in a wind instrument, the air blown through the mouthpiece and the muzzle is put into vibration, then passes through the body of the instrument, which acts as a resonance box, then exits, with the sound and timber characteristics conferred by the shape and the materials of the instrument itself.

In wind instruments such as trumpets, saxophones, clarinets and others included in the brass family, the terminal portion of the body, which is annular to and following the main opening from which the sound is released, is called the “bell” for the typically flattened shape.

There are accessories, called mute, which can be applied in correspondence of the main opening of the instrument, at the end of the bell, intended for absorbing the sound intensity or for performing particular melodies. The mute is an accessory that has the shape of a kind of a cover, possibly covered with special material, which is placed inside the bell to absorb the sound emitted or to cut off some frequencies.

Excluding the mute, each instrument has its own sound “personality”, given by the constructive features, that the player's ability can enhance but not appreciably modify, for example to better match certain music pieces.

### SUMMARY OF THE INVENTION

It is an object of the present invention to provide a resonator for wind instruments provided with a bell, particularly for wind instruments provided with secondary holes such as saxophones, flutes, clarinets, oboes or bassoons, capable of modifying the typical sound of the instrument, both in terms of power and timbre.

Yet another object of the invention is to provide a resonator that can constitute an auxiliary harmonic box for the instrument to which it is applied, designed to interact with the main resonance box in order to obtain the preferred sound modulations.

Another object of the invention is that the resonator may be realized to fit inside the bell in order to not modify the original aesthetic of the instrument.

Another object of the invention is to provide a resonator for wind instruments which can ensure a better sound diffusion on the instrument output.

Another object of the invention is that the resonator can be modeled according to different profiles in order to better meet the desired objectives.

A further object of the invention is to provide the proposed resonator both as original equipment of the instrument and as an accessory to be mounted later.

Yet another object of the invention concerns the possibility of varying within a certain “range” the resonator's position with respect to the bell, in order to personalize the acoustic response of the instrument.

Another object of the invention is to provide a resonator easy to be produced and low cost.

These and other objects are fully achieved by means of a resonator for wind instruments, of the type comprising a bell located in correspondence of the main opening of the wind instrument and comprising a resonator element, disposed in correspondence of said bell and designed to define a harmonic auxiliary surface intended to intercept and partially reflect the output sound waves of the cited bell, for increasing the intensity and/or varying the timbre.

### BRIEF DESCRIPTION OF THE DRAWINGS

The features of the invention will be better understood from the following description of preferred embodiments of the resonator for wind instruments in question according to the claims and with the aid of the accompanying drawings, in which:

FIG. 1 schematically illustrates in exploded configuration a clarinet comprising the resonator in question, in a first embodiment;

FIG. 2 shows the resonator present in the instrument of FIG. 1: FIG. 2A shows a view from below; FIG. 2B shows a side view according to the II-II line of FIG. 2A;

FIG. 3 illustrates a variant of the first embodiment of a resonator according to the present invention in which FIG. 3A shows in a view from below a resonator element of the resonator, and FIG. 3B shows in side view the bell of the resonator;

FIG. 3C shows the same bell of FIG. 3B in the opposite side view;

FIG. 4 illustrates a further variant of the first embodiment of a resonator according to the present invention in a lateral sectional view;

FIG. 5 shows a second embodiment of a resonator according to the present invention in which FIG. 5A shows a partial lateral sectional view, and FIG. 5B shows a sectional view along the V-V line of FIG. 5A;

FIG. 6 illustrates a side view of a third embodiment of a resonator according to the present invention applied to a clarinet;

FIG. 7 illustrates the resonator of FIG. 6 in side section;

FIG. 8 illustrates in side section the resonator of FIG. 6 applied to a clarinet in use;

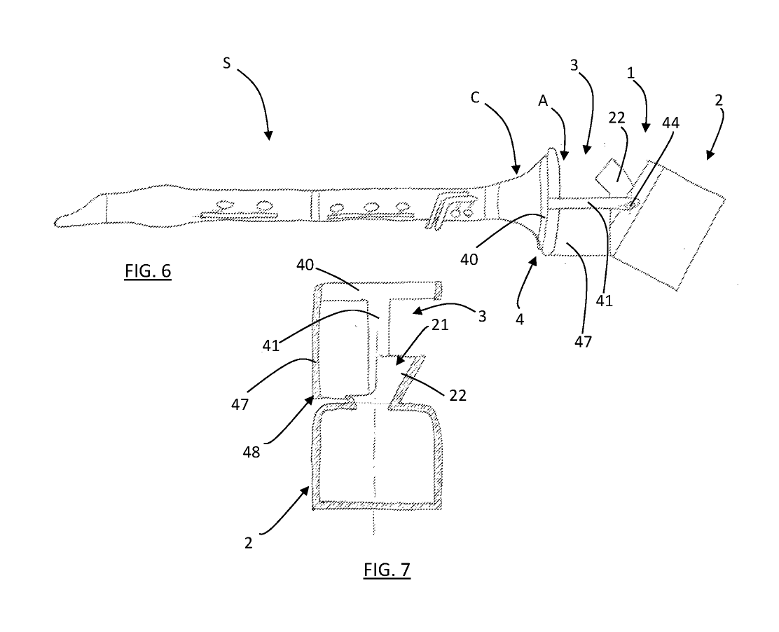

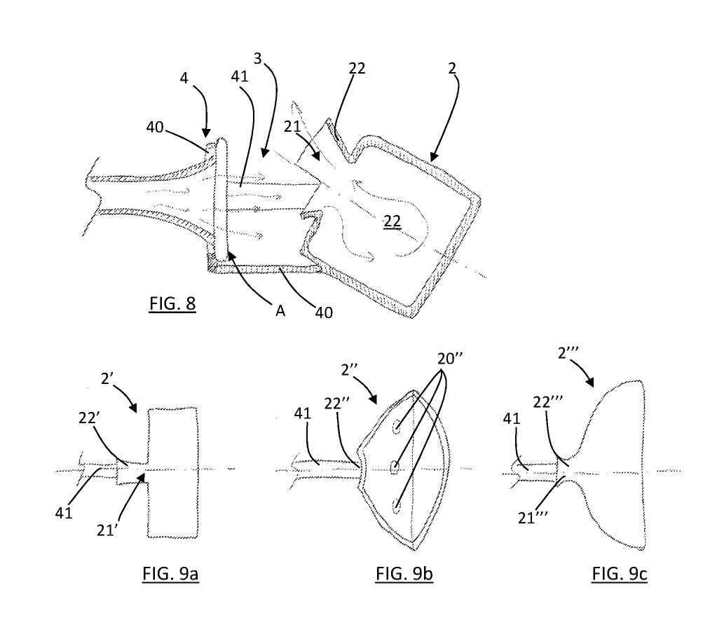

FIGS. from 9A to 9C show three variants of the embodiment of FIG. 6 of the resonator of the invention; and

FIGS. from 10A to 10F illustrate, in section, various embodiments of a fourth embodiment of the resonator of the invention.

### DETAILED DESCRIPTION

In the above said figures, the reference 1 is made to the resonator object of the invention, as a whole.

The resonator 1 is intended to be applied to wind instruments S in particular to those of the type comprising a bell portion C located around and following the main opening A of the same wind instrument S. In this way, resonator 1 interacts with sound issuing from the bell.

The wind instruments S of interest are those which, apart from having the main opening A in correspondence of the end of the bell C, have secondary holes as impedance adapters, i.e., as a non-limiting example, flutes, saxophones, clarinets, oboes, bassoons and others included in the brass family.

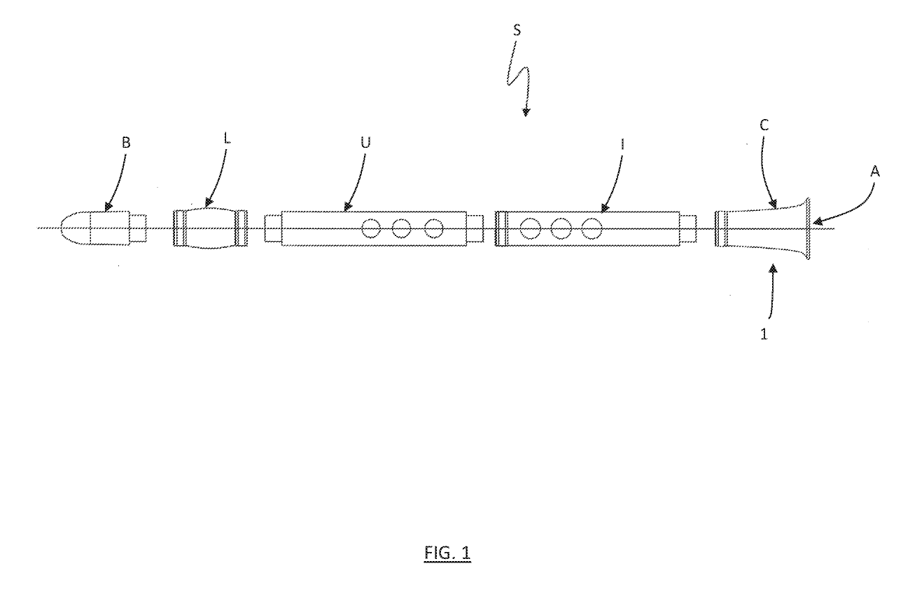

Particularly, in a first embodiment of FIG. 1, the resonator 1 comprises the bell C of a clarinet, schematically shown without the relative keys and rings and in an exploded configuration from which are recognizable the various parts that compose it and exactly a mouthpiece B, a barrel L, an upper body U, a lower body I, and of course the bell C.

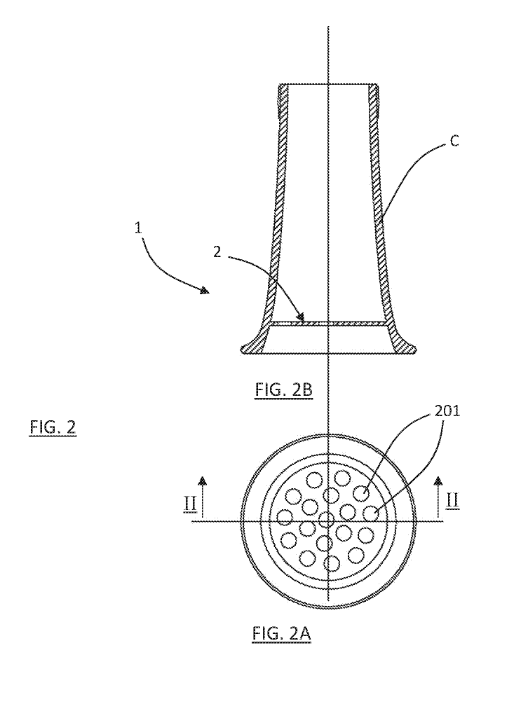

With reference to FIG. 2, according to a first embodiment of the invention, the resonator 1 is constituted by the bell C of the countersunk shape, to which is associated a resonator element 2 set therein and aimed to define an auxiliary harmonic surface intended to intercept and at least partially reflect the output sound waves of the cited bell C to increase the power and/or to change the timbre. The resonator element 2 is constituted by a flat disk provided with a plurality of holes 201 positioned within the bell C coaxially with the latter near its main opening A so as to reflect a portion of the sound waves incidental on it. The resonator element can be made as one piece together with the bell C itself. More precisely, in the depicted example, the resonator element is arranged about 1 cm from the main opening A, and in any case between 0.5 and 3 cm from it, so that it cannot be seen from the outside and presents a plurality of circular holes of the same diameter comprised between 5 mm and 15 mm arranged pseudo-randomly on the surface.

In alternative embodiments, not depicted, the resonator element may have a different number and displacement of the holes which may also be of different diameter and shape. Additionally, the disc could be bumped instead of flat.

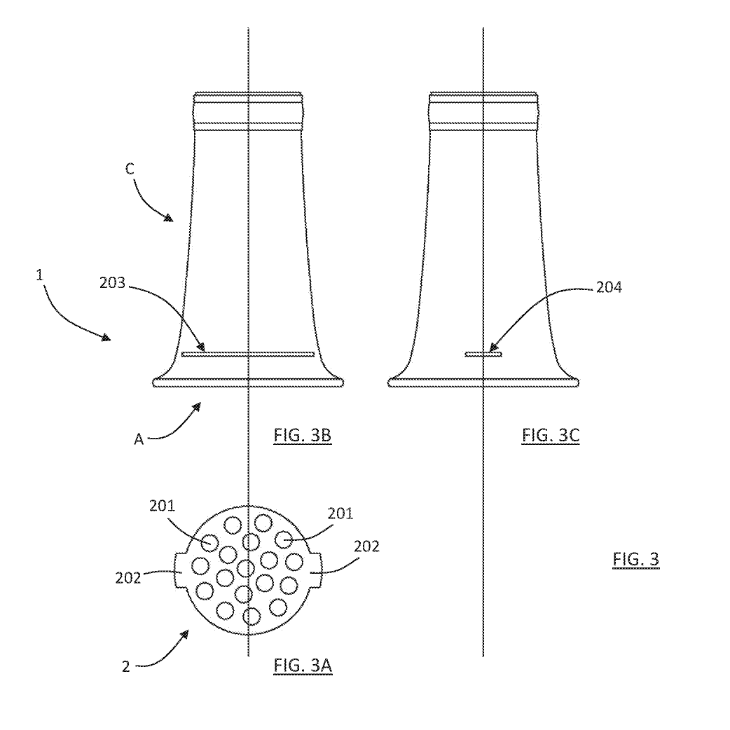

With reference to FIG. 3, according to an advantageous embodiment, a resonator substantially equal to the resonator 1 of FIG. 2 comprises a resonator element 2 constituted by a self-contained body and a bell C. The resonator element 3 has a flat disk shape provided with a plurality of holes 201 and flaps, 202, radially protruding from the outer diameter of the disc. The bell C near the main opening A is provided with a circumferential slot, 203, having an extension of slightly less than the outer diameter of the bell C but exceeding the outer diameter of the resonator element 2, and has a height slightly above the thickness of the resonator element 2. On the opposite side with respect to the one in correspondence of which the circumferential cut 203 is located, it is located a second slot, 204, of equal height and extension slightly higher than that of the flaps 202 of the resonator element 2. The resonator element 2 is suitable to be inserted into the bell C through the circumferential slot 203 sliding until one of the flaps 202 engages in the second slot 204 so that its position is referred to and maintained stable. The other flap 202 serves as a handle to insert and extract the resonator element 2 from the bell C.

The above-described embodiment allows to realize extremely low cost resonator elements 2, in a material other than that of the bell C, that can be replaced extremely quickly without having to replace the entire bell C. For example, while the bell C is preferably made of wood material, the resonator element 2 is advantageously made of plastic material.

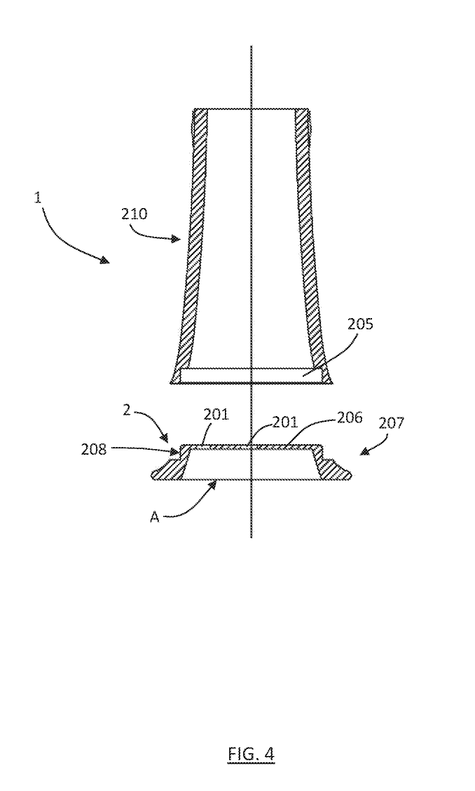

Referring to FIG. 4, according to a further advantageous embodiment, a resonator substantially equal to the resonator 1 of FIG. 2 comprises a resonator element 2 integrated in an end portion of the bell C. In correspondence of its lower end, an upper bell portion 210, has a housing 205, that is cylindrical. The resonator element 2 is in this case provided with a flat disk 206 that is provided with a plurality of holes 201 and attached on the top of an end body 207, which extends across the main opening A of the bell C and a cylindrical, threaded, coupling body 208, that is suitable for threaded insertion with minimal interference in the housing 205 of the upper bell portion 210. The end body 207 is inserted into the housing 205 of the upper bell portion 210 so as to recreate as a whole a bell C, in which the resonator element 2 is present. Alternatively, the connection between the upper bell portion 210 and the end body 207 could be realized by means of screws inserted radially transverse to end body 207.

In the above described embodiments of the invention, the presence of a perforated disk within the bell fragments the sound wave, in some cases also generating a diffraction phenomenon that produces a better and more homogeneous sound diffusion in the environment. In addition, a portion of the sound waves coming to the perforated disk are reflected inside the instrument increasing the sound pressure inside the tubular cavity of the instrument, thus enhancing and amplifying the output sound from the secondary holes.

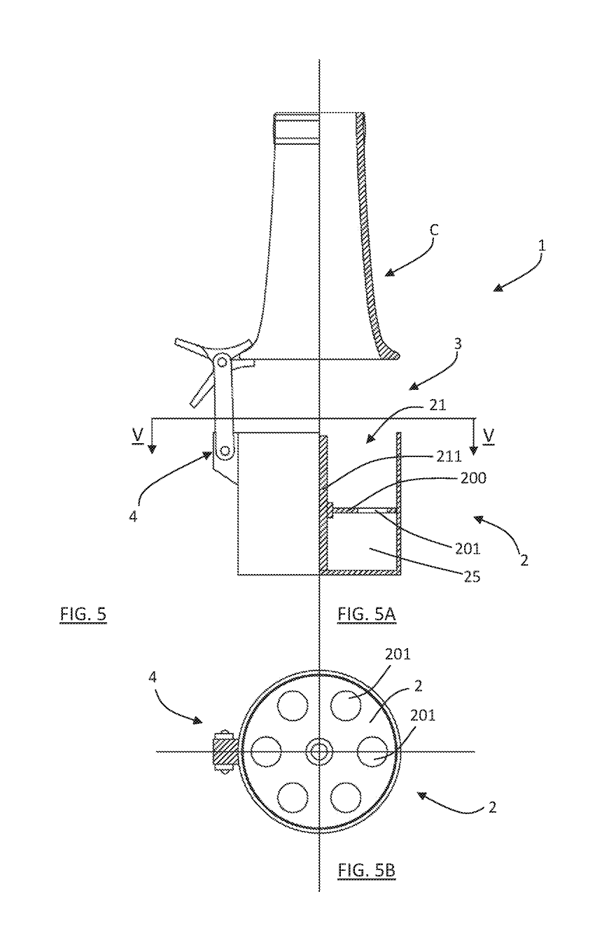

With reference to FIG. 5, in a second embodiment of the invention, the resonator 1 comprises a resonator element 2 of box-like shape arranged in front of the main opening A of said bell C by bell coupling members 4 and rods 41 which are configured so that resonator element 2 is spaced apart from bell C and defines at least an open passage 3.

Due to its conformation, the resonator element 2 is aimed to define an auxiliary harmonic box intended for intercepting the output sound waves from the bell C of the instrument S, for increasing or decreasing the sound intensity and/or varying the timbre.

The resonator element 2 has a box-like shape in order to provide an inner cavity 25 and is provided with an opening 21 substantially facing the bell C with the opening 21. The resonator element 2 has a screw element 211 protruding from the bottom of the box shaped body towards the opening 21 with which it engages a shutter element 200 that is provided with a plurality of holes 201. The shutter element 200 is rotated, such as around coupling member 4, in order to raise or lower its position so as to change the volume of the inner cavity 25 and thus the timber response of the instrument S.

With reference to FIGS. from 6 to 8, in a third embodiment, the resonator element 2 is constituted by a substantially cylindrical box shaped body having a circular opening 21 located at the axial center of the base facing the bell C and having a diameter equal to about half the diameter of the box-shaped body. In the opening 21 there is a neck element 22 protruding externally with respect to the box-shaped body and exhibiting a truncated conical shape, with half of the neck having a first height and a second half of the neck having a second height lower than the one of the first half.

The coupling members 4 are constituted by a ring 40 intended to surround the outside of the bell C and detachably lockable to the latter, from which at least two connecting rods 41 extend outwardly, preferably in opposite positions (only one of which visible in the figures), to which the respective resonator element 2 is fixed.

Obviously, the conformation of the coupling members 4 may be different and the attachment mode with respect to the instrument 5 may be different from the ring 40, such as, for example, the clamp system of FIG. 5.

In an interesting embodiment of the coupling members 4 extensible arms are provided for adjusting the distance between the bell C and the said resonator element 2 thus varying the size of the open passage 3 and, therefore, the acoustic performance of the instrument S.

By way of illustration, the above said distance may be included, depending on the type of instrument and/or resonator, between 1 cm and 15 cm.

The connecting rods 41 are associated with the resonator element 2 by means of hinge members 44 (FIG. 6) arranged, for example, in the union zones between said connecting rods 41 and the resonator element 2 aimed to allow the orientation of the latter with respect to said bell C, locally varying the size of the open passage 3 as well as the angle between the main opening A of the instrument S and the opening 21 of the resonator element 2.

The two inventive variants just described, to vary the distance of the resonator element 2 from the bell C, or to vary the angular orientation, may be present on the same coupling members 4.

Fixed to the ring 40 and to the connecting rods 41 is a retaining wall 47 that is arranged to block a portion of the opening 3 between the bell C and the resonator element 2. The retaining wall 47 has a tubular cylindrical shape and is arranged so as to block the opening 3 from the side where the neck 22 has said second lower height. An end surface 48 of the retaining wall 47 is arranged an end stop for the outer surface of the resonator element 2 so as to define a maximum angle of inclination of the resonator element 2 with respect to the main opening A of the instrument S.

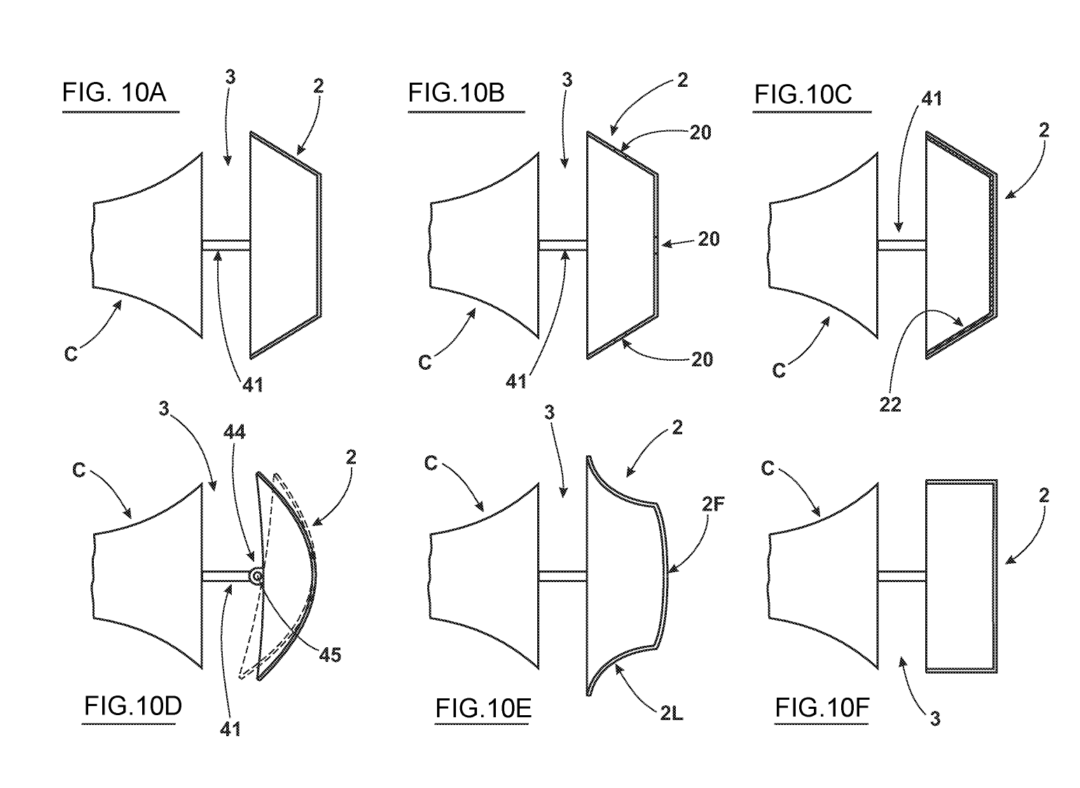

As shown in a purely exemplary and qualitative manner in FIG. 8, the output sound waves from the main opening A of the instrument S enter from the opening 21 of the resonator element 2 and inside the cavity 21 are formed stationary waves so that the resonator element 2 can amplify certain frequencies and attenuate others depending on its shape and size.

Various possible variants of the resonator element 2 are shown in FIGS. 9A, 9B and 9C. In the variant of FIG. 9A, the resonator element 2′ has a parallelepiped shape with rectangular or square base and a height lower than the base size. Its relative opening 21′ is provided with a truncated-conical neck 22′.

In the variant of FIG. 9B, the resonator element 2″ is made with two flattened semi-spherical members which, joined together, give it a lenticular shape. An opening 21″ is present at the center of one of the two flattened semi-spheres while on the same semi-sphere are displaced equidistantly from the opening 21″ and spaced angularly uniformly a series of holes 20″ with size smaller than those of the opening 21″.

In the variant of FIG. 9C, the resonator element 2′″ has a semi-spherical portion and a flat bottom, with the opening 21′″ located in the center of the semispherical portion and provided with a countersunk neck 22′″.

As already mentioned, the shape and the dimensions of the resonator element 2 determine which frequencies are amplified and which attenuated and therefore additional embodiments of the resonator element 2 can certainly be provided as needed. Moreover, the material with which the resonator element 2 is formed or coated is of considerable effect on the timber of the sound emitted by the instrument S so that the resonator element 2 can be made of metal, wood or other suitable materials and be suitably coated.

The resonator 1 according to the above described second and third embodiment, depicted in FIGS. from 5 to 9, is designed to create an auxiliary harmonic box that interacts with the main resonator of the instrument to obtain the preferred sound modulations; musicians and instrument builders will define form and size from time to time to achieve the predetermined result.

With reference to FIG. 10, in a fourth embodiment, a resonator 1 comprises a concave-shaped resonator element 2, arranged in front of the bell C so that said concavity is directed towards the bell and that between the same element 2 and bell C is defined an open passage 3, preferably of annular shape.

Due to its conformation, which will be better described in the following with reference to the variants illustrated in FIG. 10, the resonator element 2 is aimed to define an auxiliary harmonic box intended to intercept and reflect the output sound waves from the bell C of the instrument S in order to increase the power and/or to vary the timbre.

In a possible first embodiment, the concave element 2 has a paraboloid shape (FIGS. 1, 2, 4).

In a possible first variant, the resonator element 2 has a truncated cone shape (FIGS. 10A, 10B, 10C).

In a possible second variant, the resonator element 2 has a paraboloid shape (FIG. 10D). In this variant, the coupling members 4 are hinged members 44 displaced, for example, in the joining zones between said connecting rods 4 1 and the resonator element 2, aimed to allow the latter to be oriented with respect to said bell C, locally varying the size of the light passage 3, as well as the sound waves reflection angles and thus the acoustic performance of the instrument S. The orientation of the concave element 2 is stabilized by locking means, 45, for example still of the screw type, associated with the hinged members 44.

In a possible third variant, the resonator element 2 has a cup shape, defined by a side surface, 2L, with the profile of a bell closed on the front by a plate, 2F, convex towards the outside (FIG. 10E).

In a possible fourth embodiment, the resonator element 2 has a cylindrical shape (FIG. 10F).

The embodiments of the resonator element 2, described above, may be modified at the time of construction, in both form and proportions with respect to what illustrated, and thus assume different characteristics. FIG. 10B illustrates a resonator 1 whose resonator element 2 is affected by some holes 20 for the direct output of part of said sound waves.

The number of holes 20 and their position may vary depending on the acoustic response you want to obtain.

FIG. 10C illustrates a resonator 1 whose resonator element 2, from the side facing the aforesaid bell C, has associated a coating 22 of material (e.g., sponge, rubber or others) having properties such that it can modify predetermined characteristics of the sound waves that hit him.

The coating material 22 may be applied to any form of embodiment of the resonator element 2.

The resonator 1, with any embodiment or relative variants, may be provided as original part of the instrument S or as an accessory to be mounted later.

In addition, the figures show the elements of the resonator 1 of the invention, i.e., the bell C, the resonator element 2, and the coupling members 4 in a very schematic manner, as their shapes and connections can be very variable and defined by known art modalities. For example, the bell C could be integral to the body of the instrument S. Alternatively, the bell C can be an element removably associable to the body of the instrument S.

From the description above are extremely evident the peculiar characteristics of the resonator proposed by the present invention, which allows to extend the range of sounds emitted by wind instruments, both in terms of power and timbre.

In certain embodiments, the resonator is specifically designed to provide an auxiliary harmonic box that interacts with the instrument's main resonance box to obtain the preferred sound modulations; musicians and instrument building experts will define from time to time the form and the size in order to achieve the predetermined result.

The built-in simplicity of the resonator makes it interesting and easy to apply both to those who will fit as original part of the instrument and to those who will sell it as an accessory. The absence of any constructive complication and/or moving parts can advantageously reduce production costs.

It is understood however that what above said has exampling and not limiting value, therefore any modifications of detail that may be necessary to be taken for technical and/or functional reasons, are considered from now as remaining within the protective scope defined by the claims below.

1. Resonator for wind instruments that comprises a bell (C) located at a terminal end and concentric to a main sound opening (A) of said wind instrument (S), wherein said resonator comprises a resonant element (2) arranged to interact with sound issuing from said bell (C) wherein said resonant element (2) defines an auxiliary harmonic surface that intercepts and reflecting at least partially the output sound waves of said bell (C) to increase their power and/or vary their timbre.

2.-26. (canceled)

27. A resonator according to claim 1, characterized in that said resonant element (2) is disposed in front of said bell (C) and spaced therefrom.

28. A resonator according to claim 27, characterized in that said resonant element (2) has a box-like shape in order to provide an inner cavity (25) and is provided with an opening (21) placed substantially facing the bell (C) with said opening (21), said resonant element (2) having a screw element (211) protruding from the bottom of said box shaped body towards said opening (21), with said screw element (211) engaging a blinker element (200) provided of a plurality of holes (201), said blinker element (200) being rotatable to raise or lower its position in order to change the volume of said inner cavity (25).

29. A resonator according to claim 27, characterized in that said resonant element (2) comprises a box-shaped body provided on a relative side of an opening (21) very small with respect to the size of the inner volume (25) of said box-shaped body, with said opening (21) arranged substantially facing the main opening (A) of said bell (C).

30. A resonator according to claim 29, characterized in that said resonator comprises coupling members (4) configured to securely connect said resonant element (2) at a distance from said bell (C).

31. A resonator according to claim 30, characterized in that said coupling members (4) of the resonant element (2) to said bell (C) of the instrument (S) allow said resonant element to be varied in its distance from said bell.

32. A resonator according to claim 30, characterized in that said coupling members have a retaining wall (47) arranged to occlude a portion of the space between said bell (C) and said resonant element (2).

33. A resonator according to claim 29 or further characterized in that said opening (21) is provided with a neck (22) protruding externally from said box-shaped body (2) towards said bell (C).

34. A resonator according to claim 29 or further characterized in that said resonant element (2) has a cylindrical shape with said opening (21) located at substantially the axial center of the base facing towards said bell (C).

35. A resonator according to claim 29, characterized in that said resonant element (2′) has a parallelepiped shape with a rectangular base and a height lower than the base size.

36. A resonator according to claim 29, characterized in that said resonant element (2″) is constituted by two flattened semi-spheres which, joined together, confer to it a lenticular shape, said opening (21″) being located at the center of one of the two flattened semisphere, on the same semisphere being placed, equidistantly spaced from said opening (21″) and uniformly angularly spaced, a series of holes (20″) smaller in size with respect to those of said opening (21″).

37. A resonator according to claim 29, characterized in that said resonant element (2′″) has a semisphere portion and a flat bottom with said opening (21′″) located at the center of said semispherical portion and provided with a neck (22′″) of flattened shape.

38. A resonator according to claim 27, characterized in that said resonant element (2) has a concave shape, said concavity being directed towards said bell (C).

39. A resonator according to claim 27, characterized in that said resonant element (2) has a paraboloid shape.

40. A resonator according to claim 27, characterized in that said resonant element (2) has a cup shape, defined by a side surface (2L) with a bell profile closed on the front by a plate (2F) convex towards the outside.

41. A resonator according to claim 27, characterized in that in said resonant element (2) is provided at least one hole (20) for the output of said sound waves.

42. A resonator according to claim 1, characterized in that to said resonant element (2), from the side facing said bell (C), is associated a coating (22) of material having properties such as to modify predetermined characteristic of the sound waves that strike it.

43. A wind instrument that comprises: (a) a bell extending from and concentric with a main sound opening of said wind instrument, and (b) a resonant element associated with said bell and arranged to interact with sound issuing from said bell wherein said resonant element defines an auxiliary harmonic surface that intercepts and reflecting at least partially the output sound waves of said bell to increase their power and/or vary their timbre.

44. A wind instrument according to claim 43 wherein said resonant element is located within said bell.

45. A wind instrument according to claim 43 wherein said resonant element is located outside said bell and connected to said bell.
